(19) United States
(12) Patent Application Publication
(10) Pub. No.: US 2007/0037593 A1
(43) Pub. Date: Feb. 15, 2007

(54) Architectural model of a radio base station

(75) Inventors: Jacob Österling, Jarfalla (SE); Dan Lindqvist, Sollentuna (SE); Paul Teder, Taby (SE); Rutger Andersson, Kista (SE)

Correspondence Address: ERICSSON INC., 6300 LEGACY DRIVE, M/S EVR C11, PLANO, TX, 75024, US

(73) Assignee: Telefonaktiebolaget LM Ericsson, Stockholm (SE)

(21) Appl. No.: 10/551,073

(22) PCT Filed: Apr. 6, 2004
(86) PCT No.: PCT/SE04/00542

§ 371 Date: Sep. 27, 2005

(30) Foreign Application Priority Data
Apr. 24, 2003 (SE) 0301229-1

(51) Int. Cl. H04B 7/00

(52) U.S. Cl. 455/502

(57) ABSTRACT

The present invention relates to an architectural model of a radio network unit, e.g. a Radio Base Station, that separates functionality in such a way that it is possible to easily adapt the unit to various requirements and conditions. The radio network unit comprises an internal RBS-interface that subdivides the its functionality into a first part, which solely relates to the functionality of the radio network, and a second part, which solely relates to the radio part, i.e. the airborne part of the transmission. The internal interface comprises at least a link that handles the necessary additional communication that arises due to the subdivision and a link that handles the user data that is to be processed, i.e. transmitted or received, by said unit.

### FIELD OF THE INVENTION

The present invention relates to an architectural model of a radio network unit, e.g. a Radio Base Station as applied in a CDMA-based radio communication system.

### BACKGROUND OF THE INVENTION

Commonly, a Radio Base Station in a radio communication system is responsible for transmitting and receiving data to a certain range of user equipment. On the one hand, this unit takes care of the data handling related to the Radio Network functionality; on the other hand it is responsible for the airborne interface towards said user equipments. Each Radio Base Station covers a certain geographical area and provides various communication services to the user equipments within this area. A Radio Base Station is thus involved into tasks of two different techniques: Communication handling of the Radio Network functionality and handling of airborne interfaces towards user equipments. Both techniques have different requirements and develop at different pace, which is progressed, e.g., due to standardisation activities or due to various customer requirements for the implementation of radio communication networks and imply thus a wide range of products. With regard to the radio related functions still further requirements become necessary due to the location of the Radio Base Station, e.g. in an urban or rural area, and the different demands with respect to radio propagation and traffic capacity that may result . . . from this.

### SUMMARY OF THE INVENTION

Apparently, there is a need to take care of a range of different requirements with regard to the desired or required functionality of the Radio Base Station. This depends on the one hand on the intended use of the Radio Base Station and, on the other hand, on requirements of operators that use such a Radio Base Station and their definition of communication facilities, e.g., in terms of capacity and services or in terms of network design and cell planning. However, a Radio Base Station comprising a high degree of flexibility will most likely involve the problem that changes with respect to any aspect of the Radio Base Station usage will imply an at least potential influence on the entire functionality of the Radio Base Station.

Therefore, it is an object of the present invention to define a suitable architectural model of a Radio Base Station that separates functionality in such a way that it is possible to adapt the Radio Base Station to various requirements and conditions while, at the same time, the additional complexity of such a Radio Base Station can be kept as minimal as possible.

The present invention bases on the understanding that the architectural flexibility of the Radio Base Station is mainly required due to a steady increase of the functionality that is implemented in modern communication systems and due to developments and frequent modifications in the field of radio transmission.

The object of the present invention is achieved by means of a Radio Base Station comprising an internal RBS-interface that subdivides the functionality of the Radio Base Station into a first part, which solely relates to the RAN-part and thus the functionality of the radio network, and a second part, which solely relates to the radio part, i.e. the airborne part of the transmission. The internal interface comprises at least a link that handles the necessary additional communication that arises due to the subdivision and a link that handles the user data that is to be processed, i.e. transmitted or received, by said Radio Base Station.

It is a first advantage of the present invention to achieve a Radio Base Station that provides an increased flexibility to varying requirements on its functionality.

It is thus also an advantage that the Radio Base Station according to the present invention can easily be upgraded in case of evolvements and specific customer requirements.

It is a further advantage that the Radio Base Station according to the present invention facilitates a modular construction.

Other objects, advantages and novel features of the invention will become apparent from the following detailed description of the invention when considered in conjunction with the accompanying drawings and claims.

### BRIEF DESCRIPTION OF THE DRAWINGS

FIG. 1 shows an architectural model of a Radio Base Station according to the present invention.

FIG. 2 shows a part of the signal processing of user data that shall be transmitted by help of the Radio Base Station.

### DESCRIPTION OF THE INVENTION

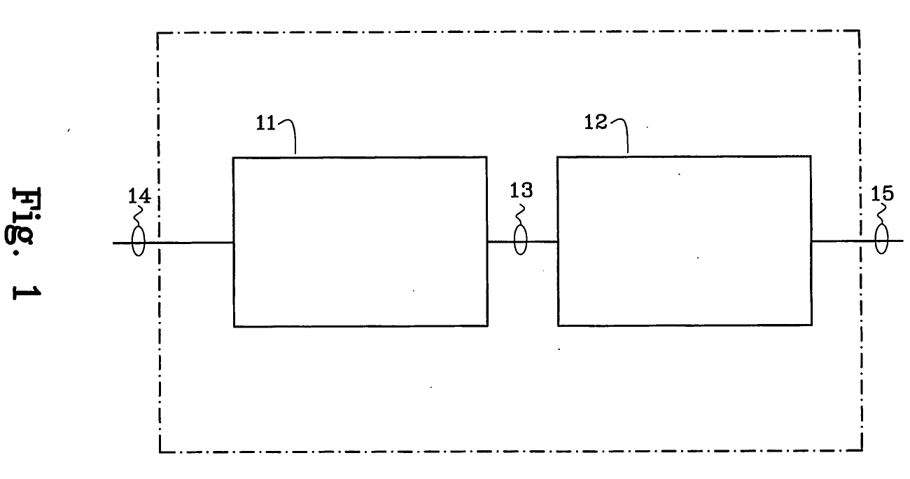

FIG. 1 shows an architectural model of a Radio Base Station 10 according to the present invention. The Radio Base Station is equipped with a Iub-interface 14 towards a central controller unit of the network, e.g. a Radio Network Controller (RNC), and comprises an interface 15 of carriers containing a plurality of Uu-interfaces, one for each of user equipment that is served by this Radio Base Station. The present invention introduces a new interface 13 within the Radio Base Station 10 that allows a subdivision of the functionalities of the Radio Base Station into distinct parts 11,12 which provides the benefit that any modification within one of the parts does not imply consequences to the respective other part. The architectural model according to the present invention intends thus to achieve a maximum integration of base station functionality that operates dependently on each other and to separate functionality that can operate independently on a certain range of definable input data. By this means, the Radio Base Station according to the present invention provides an increased flexibility for a scalable design, e.g. in terms of a scalable capacity or related to network upgrades, or with respect to conditions and requirements that are related to the airborne radio transmission.

The preferred embodiment of a Radio Base Station 10 according to the present invention, as presented in FIG. 1, is a Radio Base Station consisting of a first part 11, which comprises the RAN-functionality and a second part 12 comprising the radio-related functionality. The RAN-part 11 comprises all functionality that is related to the operation of the Radio Base Station 10 as part of the Radio Access Network. This includes the handling of user data, e.g. user data coding and decoding, and the handling of various tasks for handling of radio links, e.g. radio link setup and release, radio link supervision, power control. In addition, this part also includes the overall configuration and fault handling of the Radio Base Station 10 and the handling of the Iub-interface 14. The radio part 12 includes those functions that are strictly limited to the airborne data transmission and thus related to the chosen radio solution, e.g. regarding up/down converters, power amplification and related functions, i.e. clipping, limitations, gain control, and linearization. FIG. 1 insinuates that the radio part is strictly limited to functions that relate to one specific radio solution. However, within the scope of the present invention it is notwithstanding possible to design the architectural model in such a way that the Radio Base Station is subdivided into one RAN-part and a plurality of radio parts, whereof each radio part relates to a specific radio solution.

As already mentioned above, the subdivision of the Radio Base Station 10 into two parts 11,12 is achieved by means of introducing an internal RBS-interface 13. This interface 13 is defined in such a way that changes or evolvements of the RAN-part and/or the radio part do not affect each other. A stable internal RBS-interface must consist of at least two different kinds of links: One link, which is in the following referred to as the O&M-link, is responsible for the additional traffic that is necessary due to the subdivision of the Radio Base Station. Another link, the user data link, is responsible for carrying the user data that is transmitted from or received by the Radio Base Station.

The subdivision of the Radio Base Station functionality involves a certain amount of additional signaling between the separated parts, which is the responsibility of the O&M-link. Regarding a first aspect, both parts must agree on a number of radio related parameters. The radio part must inform the RAN-part on its capabilities such that the RAN-part is able to determine the radio-related transmission properties for the respective user data traffic. This means in particular that the radio part informs the RAN-part on its status of operability, i.e. whether there are any malfunctions in the radio part, and its capabilities at least with regard to the applied frequency and maximum permitted downlink power. This must be agreed on for each carrier, which in turn embraces a plurality of Uu-interfaces to user equipments, to which the Radio Base Station momentarily maintains an established connection. The downlink power that has been assigned to a carrier is then distributed amongst the plurality of Uu-interfaces. The RAN-part in its turn must specify at least the parameters transmission frequency and downlink power for each Uu-interface on which user data shall be transmitted. It is another responsibility of the O&M-link to provide means for the radio part to communicate with the overall configuration and fault handling of the Radio Base Station which is located in the RAN-part. Finally, there must also be measures to achieve a secure transmission via the O&M-link, which can be done by any suitable link layer fault handling, e.g. by help of parity bits or other kinds of added redundancy.

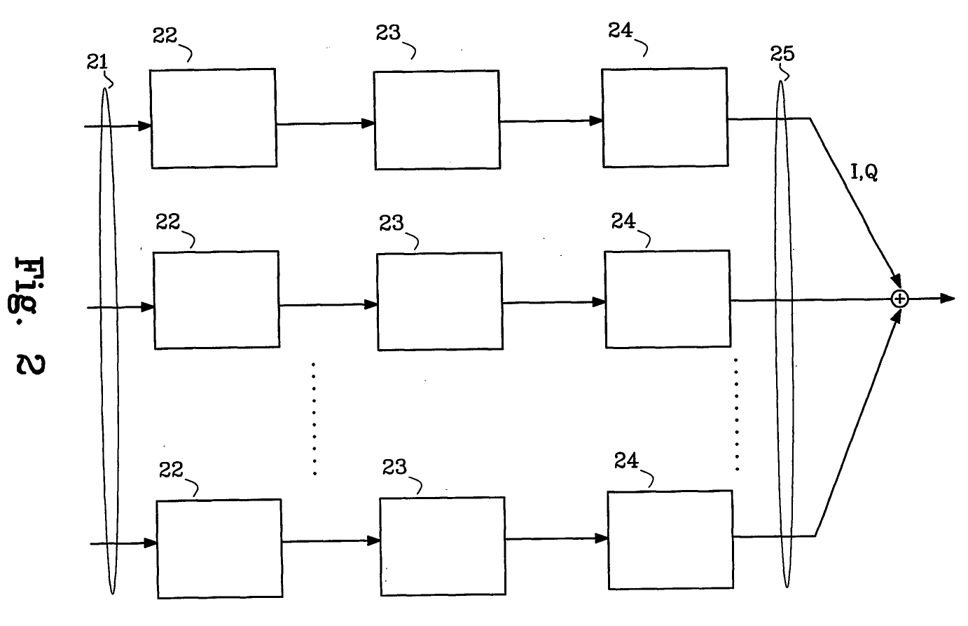

The interface between RAN-part and radio part must also provide a user data link, which denotes a high speed interface for carrying the user data that is either transmitted from or received by the Radio Base Station. The number of links in uplink and downlink direction for a physical unit in the radio part is mainly a product depend parameter but the architectural model of the Radio Base Station supports an independence between radio part division into units and interfaces. For instance, a unit comprises an O&M-link and a synchronization link and, for a single carrier unit, one user data link for uplink and downlink direction and, for a two-carrier unit two user data links in downlink direction and four user data link uplink direction. In the Radio Access Network the user data is represented by packet data that is transmitted in form of a bitstream and it is one of the responsibilities of the Radio Base Station to convert this bitstream into signals that are suitable for transmission on air. Therefore, the proposed subdivision of the functionality of the Radio Base Station according to the present invention makes it also necessary to determine where the user data is converted. In case of a subdivision into a RAN-part and a radio part, which are supposed to be independent of each other, it appears to be appropriate that the internal RBS-interface carries the user data in form of a symbol stream, which implies that RAN-part must include means for user data converting and de-converting as shown in FIG. 2. The RAN-part receives the packet data on the Iub-interface 21 in form of a bitstream and comprises the necessary means to perform the steps of channel coding 22, power control 23 and modulating 24. The user data is then transmitted over the interface 25 in form of said symbol stream, e.g. as an (I+Q)-component. The same applies mutas mutandis for user data that has been received by the user equipment.

The user data link can be supervised by various means, e.g. by means of an added redundancy as described for the O&M-link, by means of addressing, or by means of power measurements. With regard to addressing, typically each symbol stream has an identifier associated with it. This identifier associates, generally spoken, a certain geographical area to the symbol stream. The geographical area refers to, e.g., a cell, a certain cell sector, or even an antenna beam and specifies a distinct antenna in case there are several antennas and the applied frequency. This identifier is not connected to a physical unit in the radio part; however, it must be known to both the unit that is responsible for the overall configuration handling and the radio part. The identifier is inserted by the transmitting party and supervised by the receiving party, which facilitates fault locating in the routing of the symbol stream through the Radio Base Station. Another alternative to supervise the user data link is by means of power measurements during a given measurement period of the TX symbol power, which denotes the average symbol power in the downlink, and the RX symbol power, which denotes the average symbol power in the uplink. The measurement result is sent either embedded in the user data link or the O&M-link. Corresponding measurements are done on the receiving part of the interface. Faults on the radio path configuration can be located by means of an automatic gain calibration.

In a preferred embodiment of the present invention the internal RBS-interface also comprises an optional synchronization link. This link is optional depending on the hardware implementation of the radio parts. In certain implementations it might be necessary to transfer both a frequency reference and a time reference, i.e. a frame structure, to the radio parts. This is especially helpful when RAN-part and radio part are physically distant from each other. A preferable implementation is to embed the time reference within the symbol stream, e.g. indicating the first symbol in the frame, and to embed the frequency reference as the interface bit clock. The supervision of the synchronization link is preferably integrated with an interface delay calibration, i.e. the time reference sent by the RAN-part is echoed back by the radio part and the round trip delay is measured. The knowledge of this delay can be used to trim the TX Diversity delays and RAKE usage. Alternatively, the echoing can be done the other way around, i.e. the radio part measures the delay. This might be advantageous in systems with many units in the radio part and only one RAN-part.

1-10. (canceled)

11. A radio network unit responsible for transmission and reception of user data to and from one or more user equipments in a radio communication network, comprising:
a unit-internal interface that subdivides the functionality of the radio network unit into a first part, which solely relates to the functionality of the radio access network, and at least one second part, which solely relates to the airborne radio transmission; and,
said interface comprising at least a first link for handling communication that occurs due to the subdivision of functionality and a second link for handling user data that is to be processed by said radio network unit.

12. The radio network unit according to claim 11, wherein the first part comprises first means for configuration and fault handling of the entire radio network unit, the second part comprises second means for configuration and fault handling of the second part, and wherein said first and second means are interconnected over said unit-internal interface.

13. The radio network unit according to claim 11, wherein said unit-internal interface comprises a synchronization link providing at least one of a frequency or time reference.

14. The radio network unit according to claim 11, wherein the first part comprises means for converting a bitstream of packet data into a stream of data symbols and vice versa.

15. The radio network unit according to claim 11, wherein the first part comprises means for indicating at least the parameters transmission frequency and downlink power for user data that is transmitted to one of the user equipments.

16. The radio network unit according to claim 11, wherein the second part comprises means for indicating its status of operability and its transmission capabilities.

17. The radio network unit according to claim 16, wherein the transmission capabilities are indicated at least by help of parameters for the available transmission frequencies and the maximum permitted downlink power.

18. The radio network unit according to claim 11, wherein the unit constitutes a Radio Base Station in a CDMA-based radio communication system.
